(19) United States
(12) Patent Application Publication
(10) Pub. No.: US 2026/0360690 A1
(43) Pub. Date: Nov. 12, 2026

(54) LITHIUM SECONDARY BATTERY COMPRISING AMORPHOUS SILICON THIN FILM ANODE AND MANUFACTURING METHOD THEREFOR

(71) Applicant: Industry-University Cooperation Foundation Hanyang University Erica Campus, Ansan-si, Gyeonggi-do (KR)

(72) Inventors: Kuk Young CHO, Ansan-si, Gyeonggi-do (KR); Jin Sol IM, Ansan-si, Gyeonggi-do (KR); Jun Hyeok SEO, Ansan-si, Gyeonggi-do (KR); Min Jae KIM, Ansan-si, Gyeonggi-do (KR)

(21) Appl. No.: 19/486,956

(22) PCT Filed: Apr. 25, 2024
(86) PCT No.: PCT/KR2024/005561

§ 371 Date: Feb. 25, 2026

(30) Foreign Application Priority Data
May 22, 2023 (KR) 10-2023-0065563

(51) Int. Cl. H01M 4/04; H01M 4/38; H01M 10/0525

(52) U.S. Cl. CPC H01M 4/0428; H01M 4/0404; H01M 4/0435; H01M 4/386; H01M 10/0525

(57) ABSTRACT

Provided is a lithium secondary battery characterized by including: a negative electrode in which an amorphous silicon active material is laminated on a negative electrode current collector; a positive electrode in which a positive electrode active material is laminated on a positive electrode current collector; and an electrolyte having low reactivity with the negative electrode, wherein the positive electrode, the negative electrode, and the electrolyte are assembled under pressure.

### CROSS-REFERENCE TO RELATED APPLICATIONS

The present application is a national stage application of an international application PCT/KR2024/005561 filed on Apr. 25, 2024, which claims the benefit of the filing date of Korean Patent Application No. 10-2023-0065563, filed with the Korean Intellectual Property Office on May 22, 2023, the entire contents of which are incorporated herein by reference.

### TECHNICAL FIELD

The present invention relates to a lithium secondary battery including an amorphous silicon thin film negative electrode. More specifically, the present invention relates to a lithium secondary battery that includes a positive electrode, an amorphous silicon thin film negative electrode, and an electrolyte having low reactivity with the negative electrode, enables fast charging, and suppresses the delamination of electrodes during operation.

### BACKGROUND

As technological development and demand for electronic devices continue to increase today, lithium secondary batteries are being studied in a diverse and wide range of fields, from small devices such as mobile phones, laptops, and camcorders to large devices such as electric vehicles and power storage systems. Particularly, the research direction of lithium secondary batteries is mainly aimed at high energy density, stability, and safety, and significance is placed on providing a safe lithium secondary battery having a long lifespan and high capacity.

Lithium secondary batteries as secondary batteries have the advantage of having a larger capacity and higher energy density per unit area than nickel-cadmium and manganese batteries. However, lithium secondary batteries have the disadvantage of being prone to overheating and having poor output, making these lithium secondary batteries difficult to use as next-generation batteries.

In addition, since lithium secondary batteries use liquid electrolytes including organic solvents that pose a high risk of leakage, fire, or the like, there are the tasks of essentially ensuring safety. Accordingly, interest in and research on lithium secondary batteries that have good safety, high energy density, and high output have increased significantly.

Recently, research on lithium secondary batteries using a Li—Si-based material as the next-generation negative electrode active material has been actively conducted. The theoretical specific capacity of silicon (Si) is 3579 mAh/g, which is superior to the specific capacity of graphite carbon, a commercial negative electrode, which is 372 mAh/g. However, silicon has low electrical conductivity and volume expansion and contraction due to repeated intercalation and deintercalation of lithium occurring during charge and discharge, which causes the cracking of the electrode, and the active material is peeled off due to continuous side reactions with the organic electrolyte. This causes electrical short circuits between electrode/current collector, electrode/electrode, and electrode/electrolyte, resulting in the deterioration of continuous cycle characteristics.

To improve the low electrical conductivity and surface deterioration due to volume change of silicon negative electrodes, various research methods such as silicon structure improvement and surface modification are being conducted, and there is a need to realize the manufacture of lithium secondary batteries having high reversible capacity and excellent charge/discharge cycle characteristics through more diverse research.

### DISCLOSURE

### Detailed Description

An object to be achieved by the present invention is to provide a silicon negative electrode and a lithium secondary battery including the same having fast charging and long life characteristics by improving the existing low electrical conductivity and deterioration problems due to volume change.

However, the problems to be solved by the present invention are not limited to the above-described problems, and other problems not described above will be clearly understood by those skilled in the art from the description below.

One embodiment of the present invention provides a lithium secondary battery including: a negative electrode in which an amorphous silicon active material is laminated on a negative electrode current collector; a positive electrode in which a positive electrode active material is laminated on a positive electrode current collector; and an electrolyte having lower reactivity with the negative electrode; wherein the positive electrode, the negative electrode, and the electrolyte are assembled under pressure.

The amorphous silicon active material may have a thickness of 0.05 μm or more and 10 μm or less.

The amorphous silicon active material may be doped with one or more elements of nitrogen, oxygen, phosphorus, and arsenic. Preferably, the amorphous silicon active material may be doped with the element phosphorus (P).

The amorphous silicon active material may have an element doping concentration of 1.0×10¹¹ atoms/cm³ or more and 5.0×10²² atoms/cm³ or less.

The amorphous silicon active material may be laminated on the negative electrode current collector by a plasma-enhanced chemical vapor deposition (PECVD) method.

The negative electrode current collector may include one or more of Ni, Cu, Fe, Ti, C, Ag, and stainless steel.

The positive electrode active material may include an oxide including Li and at least one of Ni, Co, Mn, Fe, Al, Mg, and V, or a mixture thereof.

The positive electrode current collector may include one or more of Al, Fe, Ni, Ti, Ag, and stainless steel.

The electrolyte having low reactivity with the negative electrode may be at least one of an oxide-based electrolyte, a halide-based electrolyte, a complex hydride-based electrolyte, and a sulfide-based electrolyte.

When the lithium secondary battery is manufactured, pressurization may be performed at a pressure of 4 MPa or more and 125 MPa or less.

Another embodiment of the present invention provides a method of manufacturing a lithium secondary battery comprising: manufacturing a positive electrode by applying a positive electrode active material slurry including a positive electrode active material onto a positive electrode current collector; manufacturing a negative electrode by depositing an amorphous silicon active material on a negative electrode current collector; and manufacturing an electrolyte having low reactivity with the negative electrode, bonding the positive electrode to one surface of the electrolyte, and bonding the negative electrode to the other surface, wherein the positive electrode, the negative electrode, and the electrolyte are assembled under pressure.

### Advantageous Effects

A lithium secondary battery according to one embodiment of the present invention uses a plasma-enhanced chemical vapor deposition (PECVD) process to manufacture a negative electrode by depositing an amorphous silicon active material on a negative electrode current collector, thereby enabling the doping of another element simultaneously with silicon deposition, achieving a fast deposition speed, and making it easily applicable to large-area processes.

In addition, a lithium secondary battery according to one embodiment of the present invention has the advantage of being capable of fast charging because its electrical conductivity is improved by doping another element into amorphous silicon.

Additionally, since a lithium secondary battery according to one embodiment of the present invention is manufactured under pressurized conditions, an amorphous silicon negative electrode has an advantage in suppressing the peeling thereof due to volume change during battery operation.

The effects of the present invention are not limited to the above-described effects, and effects not described will be clearly understood by those skilled in the art from the present specification and the attached drawings.

### DESCRIPTION OF DRAWINGS

FIG. 1 is a cross-sectional view of a lithium secondary battery according to one embodiment of the present invention.

FIGS. 2A to 2C are SEM images of an amorphous silicon (Si) thin film after operation of a lithium secondary battery according to Comparative Examples 1 to 3, and

FIG. 2D is an SEM image of an amorphous Si thin film after operation of a lithium secondary battery according to Example 1.

FIG. 3 is a graph showing the capacity change according to cycle operation of lithium secondary batteries manufactured in Example 1 and Comparative Example 1 of the present invention.

### BEST MODE

Throughout the present specification, when a certain portion is said to “include” a certain component, this does not mean that the portion excludes other components, but that the portion may further include other components, unless otherwise specifically stated.

Throughout the present specification, when a certain member is said to be located “on” another member, this includes not only cases where the certain member is in contact with the other member, but also cases where another member exists between the two members.

Hereinafter, the present invention will be described in more detail.

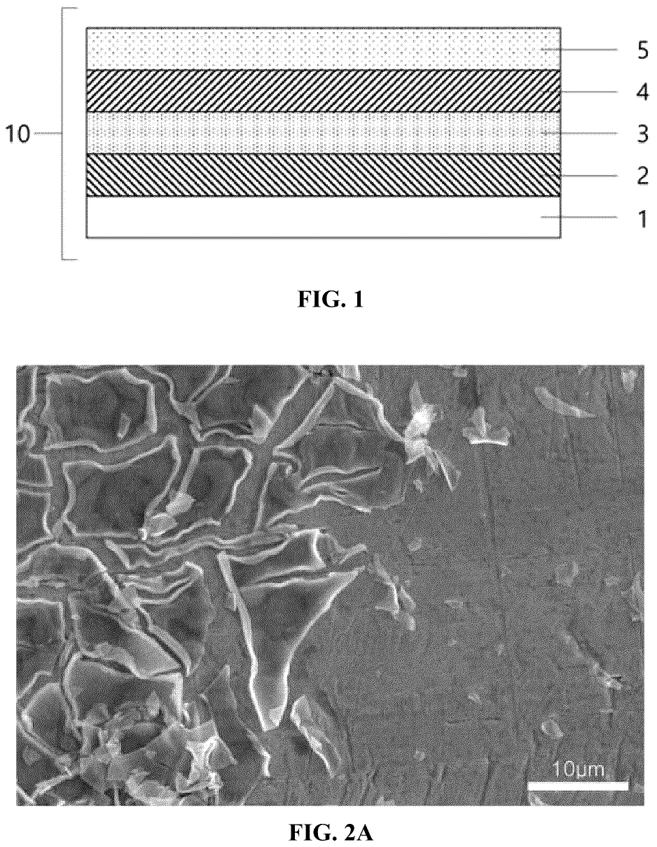

FIG. 1 is a cross-sectional view of a lithium secondary battery according to one embodiment of the present invention. Referring to FIG. 1, one embodiment of the present invention may provide a lithium secondary battery 10 comprising: a negative electrode in which on an amorphous silicon active material 2 is laminated on a negative electrode current collector 1; a positive electrode in which a positive electrode active material 4 is laminated on a positive electrode current collector 5; and an electrolyte 3 having low reactivity with the negative electrode, wherein the positive electrode, the negative electrode, and the electrolyte are assembled under pressure.

The negative electrode current collector 1 is not limited as long as it has conductivity and does not cause chemical changes during battery charging and discharging, and is made of at least one selected from Ni, Cu, Fe, Ti, C, Ag, and stainless steel, and is preferably made of Cu, Ni, or stainless steel.

The amorphous silicon active material 2 has an amorphous structure and is manufactured by depositing the amorphous silicon active material 2 on the negative electrode current collector. A silicon active material deposition method may include plasma-enhanced chemical vapor deposition (PECVD), radio frequency (RF) sputtering, chemical vapor deposition (CVD), metal-organic chemical vapor deposition (MOCVD), atomic layer deposition (ALD), molecular layer deposition (MLD), and laser-assisted deposition (LAD), and PECVD is preferably used.

The amorphous silicon active material 2 has a thickness of 0.05 μm or more and 10 μm or less.

When the thickness of the amorphous silicon active material 2 is less than 0.05 μm, it may be difficult to use the lithium secondary battery due to low energy density.

Meanwhile, when the amorphous silicon active material 2 has a thickness exceeding 10 μm, it may be difficult to use the lithium secondary battery due to the problem of peeling caused by a large volume change during battery operation.

The amorphous silicon active material is disposed on the negative electrode current collector using a PECVD method.

In the process of arranging the amorphous silicon active material 2 on the negative electrode current collector 1 using PECVD, at least one of silane, disilane, dichlorosilane, and tetraethylorthosilicate may be used as a precursor gas.

In the process of arranging the amorphous silicon active material 2 on the negative electrode current collector 1, argon, helium, hydrogen, or the like may be used as a carrier gas, and hydrogen is preferably used.

The amorphous silicon active material 2 is doped with one or more elements of nitrogen, oxygen, phosphorus, and arsenic. Preferably, the amorphous silicon active material is doped with the element phosphorus (P).

In the doping material for the amorphous silicon active material 2, the desired type of doping may vary according to the type of dopant gas. The dopant gas may include ammonia, phosphine, nitrogen, nitrogen trifluoride, trimethylphosphine, triethylphosphine, oxygen, ozone, carbon dioxide, arsine, tertiarybutylarsine, or trimethylarsine, and the like.

The amorphous silicon active material 2 has an element doping concentration of 1.0×10¹¹ atoms/cm³ or more and 5.0×10²² atoms/cm³ or less.

When the doping concentration of the amorphous silicon active material 2 is less than 1.0×10¹¹ atoms/cm³, it may be difficult to use the lithium secondary battery due to low electrical conductivity.

Meanwhile, when the doping concentration of the amorphous silicon active material 2 exceeds 5.0×10²² atoms/cm³, the energy density may be low, thereby making it difficult to use the lithium secondary battery.

The electrolyte 3 having low reactivity with the negative electrode is an ionic inorganic material, and is at least one selected from sulfide-based, oxide-based, complex hydride-based, and halide-based inorganic materials.

The sulfide-based ionic conductive inorganic particles may include Li₆PS₅Cl (LPSCl), L₁₀GeP₂S₁₂ (LGPS), Li₂S—P₂S₅ (LPS) solid electrolyte materials, and the like. According to one embodiment of the present invention, LPSCk having an argyrodite structure may be used as a sulfide-based solid electrolyte.

The oxide-based ionic conductive inorganic particles may include Li₃ₓLa_{2/3-x}TiO₃ (LLTO), L₇La₃Zr₂O₁₂(LLZO), and the like.

The halide-based ionic conductive inorganic particles may include Li₃YC₁₆, Li₃YBr₆, and the like.

The complex hydride-based ionic conductive inorganic particles may include LiBH₄, LiNH₂, LiAlH₄, and the like.

A thickness of the electrolyte 3 having low reactivity with the negative electrode is not particularly limited, but may be, for example, 20 μm or more and 1000 μm or less.

The positive electrode active material 4 may include an oxide including Li and at least one of Ni, Co, Mn, Fe, Al, Mg, and V, or a mixture thereof, and the oxide including Li may include lithium cobalt oxide, lithium nickel oxide, lithium manganese oxide, lithium phosphide, and lithium vanadium oxide, but is not limited thereto.

The positive electrode current collector 5 is not limited as long as it has conductivity and does not cause chemical changes during battery charging and discharging, and is made of at least one selected from Al, Fe, Ni, Ti, Ag, and stainless steel, but is not limited to these.

The positive electrode, the negative electrode, and the electrolyte are assembled under pressure.

The lithium secondary battery 10 according to one embodiment of the present invention is manufactured by applying pressure in a pressure range of 4 MPa or more and 125 MPa or less during manufacturing.

When the pressure range of the lithium secondary battery 10 is less than 4 MPa during manufacturing, the interfacial non-contact between the electrolyte and the negative electrode or the positive electrode may occur, making it difficult to implement the lithium secondary battery.

In addition, when the pressure range of the lithium secondary battery 10 exceeds 125 MPa during manufacturing, cracks may occur in the negative electrode or the positive electrode due to excessive pressure, making it difficult to implement the lithium secondary battery, and there may be a problem of reduced charge and discharge capacity.

Another embodiment of the present invention provides a method of manufacturing a lithium secondary battery, including: an operation of manufacturing a positive electrode by applying a positive electrode active material slurry including a positive electrode active material onto a positive electrode current collector; an operation of manufacturing a negative electrode by depositing amorphous silicon on a negative electrode current collector; and an operation of manufacturing an electrolyte having low reactivity with the negative electrode, bonding the positive electrode to one surface of the electrolyte, and bonding the negative electrode to the other surface; wherein the positive electrode, the negative electrode, and the electrolyte are assembled under pressure.

A method of manufacturing a lithium secondary battery according to one embodiment of the present invention may first include an operation of manufacturing a positive electrode by applying a positive electrode active material slurry including a positive electrode active material onto a positive electrode current collector.

The positive electrode active material slurry may be manufactured by mixing a conductive material, a binder, and an ionic inorganic material with the positive electrode active material including an oxide including Li and at least one of Ni, Co, Mn, Fe, Al, Mg, and V, or a mixture thereof in a solvent

The conductive material may be, for example, carbon (for example, Super-P). In addition, the conductive material may be one selected from the group consisting of carbon black, acetylene black, Ketjen black, and carbon fibers, or a mixture of two or more thereof.

The binder may be, for example, nitrile butadiene rubber (NBR). In addition, the binder may be a polymer compound obtained by mixing one or more selected from diene-based, fluorine-based, acrylic-based, and silicone-based polymer compounds.

The solvent may be, for example, a toluene solvent. In addition, the solvent may be any one selected from non-polar organic solvents such as anisole and xylene, or a mixed organic solvent including a mixture of these.

The ionic inorganic material is at least one of an oxide-based ionic inorganic material, a halide-based ionic inorganic material, a complex hydride-based ionic inorganic material, and a sulfide-based ionic inorganic material.

The positive electrode may be manufactured by applying the positive electrode active material slurry onto the positive electrode current collector made of at least one selected from Al, Fe, Ni, Ti, Ag, and stainless steel.

Subsequently, an operation of manufacturing a negative electrode by depositing amorphous silicon on the negative electrode current collector may be performed.

In the amorphous silicon negative electrode, the negative electrode is manufactured by depositing amorphous silicon on the negative electrode current collector using a PECVD method.

In the process of applying the amorphous silicon active material 2 onto the negative electrode current collector 1 using PECVD, at least one of silane, disilane, dichlorosilane, and tetraethylorthosilicate may be used as a precursor gas.

In the process of applying the amorphous silicon active material 2 onto the negative electrode current collector 1, argon, helium, hydrogen, or the like may be used as a carrier gas, and hydrogen is preferably used.

The amorphous silicon active material 2 is doped with one or more elements of nitrogen, oxygen, phosphorus, and arsenic. Preferably, the amorphous silicon active material is doped with the element nitrogen.

In the doping material for the amorphous silicon active material 2, the desired type of doping may vary according to the type of dopant gas. The dopant gas may include ammonia, phosphine, nitrogen, nitrogen trifluoride, trimethylphosphine, triethylphosphine, oxygen, ozone, carbon dioxide, arsine, tertiarybutylarsine, and trimethylarsine.

The amorphous silicon active material 2 has a doping concentration of 1.0×10¹¹ atoms/cm³ or more and 5.0×10²² atoms/cm³ or less.

When the doping concentration of the amorphous silicon active material 2 is less than 1.0×10¹¹ atoms/cm³, it may be difficult to use the lithium secondary battery due to low electrical conductivity.

Meanwhile, when the doping concentration of the amorphous silicon active material 2 exceeds 5.0×10²² atoms/cm³, energy density may be low, thereby making it difficult to use the lithium secondary battery.

Subsequently, an operation of manufacturing an electrolyte having low reactivity with the negative electrode, bonding the positive electrode to one surface of the electrolyte, and bonding the negative electrode to the other surface may be performed

Finally, the positive electrode, the negative electrode, and the electrolyte are assembled under pressure to manufacture the lithium secondary battery.

According to one embodiment of the present invention, the lithium secondary battery is manufactured by pressurizing in a pressure range of 4 MPa or more and 125 MPa or less during manufacturing.

When the pressure range of the lithium secondary battery is less than 4 MPa during manufacturing, the interfacial non-contact between the electrolyte and the negative electrode or positive electrode may occur, thereby making it difficult to implement the lithium secondary battery.

In addition, when the pressure range of the lithium secondary battery exceeds 125 MPa during manufacturing, cracks may occur in the negative electrode or the positive electrode due to excessive pressure, thereby making it difficult to implement the lithium secondary battery, and there may be a problem of reduced charge and discharge capacity.

### Modes of the Invention

Hereinafter, the present invention will be described in detail using examples to provide a specific description thereof. However, the examples according to the present invention may be modified in many different forms, and the scope of the present invention is not to be construed as being limited to the examples described below. The examples of the present specification are provided to more completely describe the present invention to a person of average skill in the art.

### EXAMPLES

### Example 1

A negative electrode was manufactured by depositing an n-type phosphorus (P)-doped amorphous silicon (Si) thin film on a copper (Cu) substrate using a PECVD method. After adjusting from an initial vacuum of 6.7×10⁻⁴ Pa to a working pressure of 79 Pa, the P-doped amorphous Si thin film was deposited under the conditions of a flow ratio of hydrogen, silane, and phosphine gases of 4:1:1, a high-frequency power of 30 W, and a working temperature of 220 °C. LPSCl was used as an electrolyte and a lithium metal was used as a positive electrode. The negative electrode, the electrolyte, and the positive electrode were assembled under a pressure of 20 MPa to manufacture a lithium secondary battery.

### Comparative Example 1

An amorphous Si thin film was deposited on a Cu substrate using a PECVD method. After adjusting from an initial vacuum of 6.7×10⁻⁴ Pa to a working pressure of 53.3 Pa, the amorphous Si thin film was deposited under the conditions of a flow rate of hydrogen and silane gases of 1:1, a high-frequency power of 30 W, and a working temperature of 220 °C. A mixture in which 10 wt % fluoroethylene carbonate (FEC) was added to a mixture in which 1 M LiPF₆ was added to a mixed solvent (volume ratio=1:1) of ethylene carbonate (EC) and diethyl carbonate (DEC) was used as the electrolyte, and a lithium metal was used as a positive electrode to manufacture a lithium secondary battery.

### Comparative Example 2

A lithium secondary battery was manufactured using the thin film according to Example 1 of the present invention as a negative electrode. Here, the P-doped amorphous Si thin film of Example 1 was used as the negative electrode, and a mixture in which 10 wt % fluoroethylene carbonate (FEC) was added to a mixture in which 1 M LiPF₆ was added to a mixed solution (volume ratio=1:1) of ethylene carbonate (EC) and diethylene carbonate (DEC) was used as the electrolyte, and a lithium metal was used as a positive electrode to manufacture a lithium secondary battery.

### Comparative Example 3

The amorphous Si thin film according to Comparative Example 1 of the present invention was used as a negative electrode, LPSCl was used as an electrolyte, and a lithium metal was assembled as a positive electrode under a pressure of 20 MPa to manufacture a lithium secondary battery.

### Comparative Example 4

The P-doped amorphous Si thin film according to Example 1 of the present invention was used as a negative electrode, LPSCl was used as an electrolyte, and a lithium metal was assembled as a positive electrode without pressurization to manufacture a lithium secondary battery.

### Comparative Example 5

The P-doped amorphous Si thin film according to Example 1 of the present invention was used as a negative electrode, LPSCl was used as an electrolyte, and a lithium metal was assembled as a positive electrode under a pressure of 130 MPa to manufacture a lithium secondary battery.

### Experimental Example 1: Electrical Conductivity Measurement Evaluation

An electrical conductivity oc was evaluated by applying a transfer line method (TLM) to the electrical characteristics of Example 1 and Comparative Example 1, and the results are shown in Table 1. Contact resistance evaluation is performed by forming a TLM element structure with different inter-metal distances and measuring a resistance according to an inter-metal distance, and obtaining a contact resistance R_{c} from the y-intercept of this graph and a sheet resistance Rₛ from the slope. Here, the contact resistivity was calculated from the following Equation 1, which is the relationship between an average transfer distance L_{T} between metals, a width W of the metal, the contact resistance R_{c}, the surface resistance R_{S}, and the contact resistivity ρ_{c}. The electrical conductivity σ_{c} was calculated through the contact resistance ρ_{c} calculated from the following Equation 2.

R_{c}=ρ_{c}/(L_{T}W)=(R_{S}L_{T})/W [Equation 1]

σ_{c}=1/ρ_{c} [Equation 2]

TABLE 1

| | Comparative Example 1 | Example 1: |
|---|---|---|
| Electrical conductivity | 6.72 × 10⁻⁸ S/cm | 6.87 × 10⁻³ S/cm |

Referring to Table 1, it can be seen that the silicon thin film negative electrode according to Example 1 of the present invention showed a higher electrical conductivity than of Comparative Example 1. Since Example 1 has high electrical conductivity, rapid charging and discharging at a high current (1 C) are possible during the operating process, while Comparative Example 1, which has low electrical conductivity, has a high overvoltage and puts a strain on the electrodes during rapid charging and discharging under high current conditions.

### Experimental Example 2: Evaluation of Operating Characteristics of Amorphous Silicon Thin Film

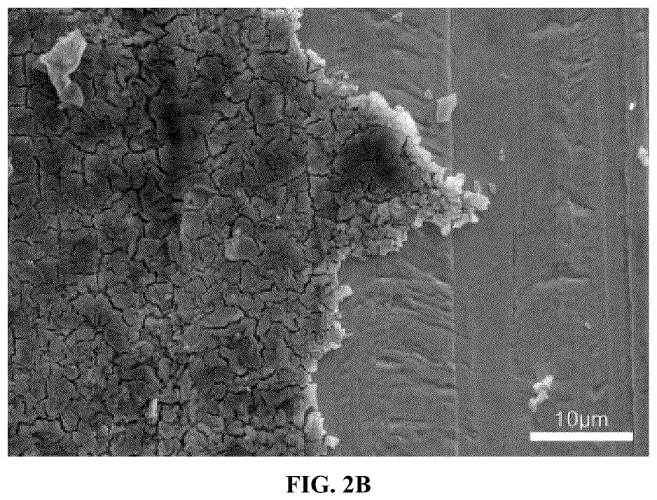

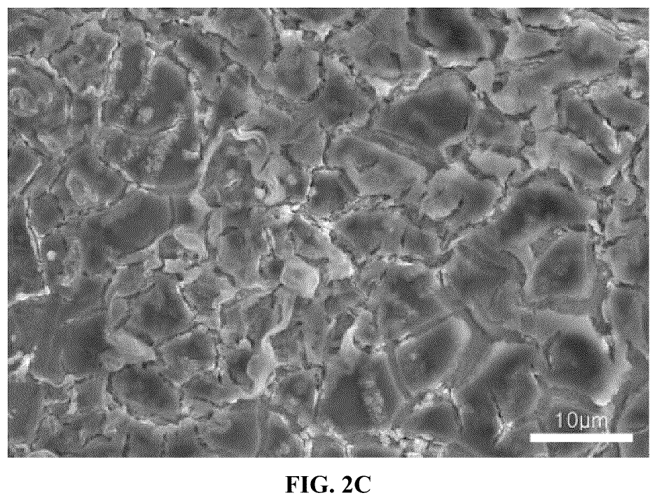

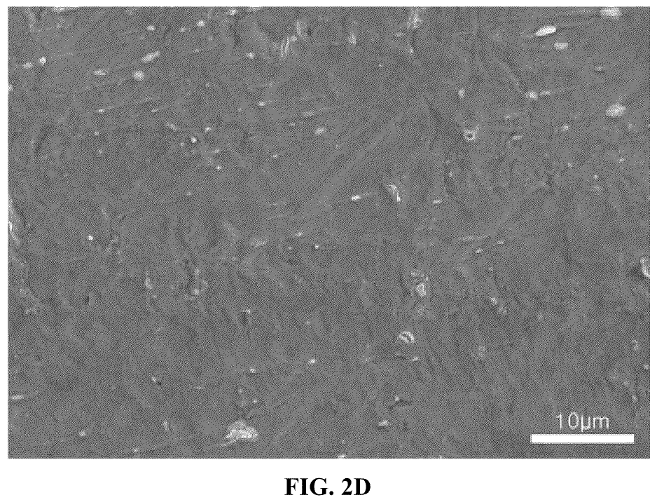

Whether the lithium secondary batteries according to Example 1 and Comparative Examples 1 to 5 were operational and the presence of cracks on the thin film surface after charge and discharge operation were checked, and the evaluation results are shown in Table 2. The charge and discharge operation was measured by performing 100 charge and discharge cycles each under a current condition of 1 C at an operating voltage of 1.5 V to 0.1 V. In this case, the operating status was evaluated as ◯ when a capacity of 500 mAh/g or more was developed during charge and discharge operation, and x when it was not developed. Referring to FIGS. 2A-2D, surface stability was evaluated as x when the cracking and peeling of the Si thin film occurred, Δ when cracking occurred, and ◯ when neither cracking nor peeling occurred.

Referring to Table 2, it can be seen that the battery manufactured without pressurization in Comparative Example 4 and the battery manufactured by pressurizing at 130 MPa or more in Comparative Example 5 did not operate due to interfacial non-contact and excessive pressure.

Referring to FIG. 2D, it can be seen that the P-doped amorphous Si thin film manufactured in Example 1 did not experience any cracking or peeling of the thin film after operation.

Referring to FIGS. 2A and 2B, it can be seen that the amorphous Si thin films manufactured in Comparative Example 1 and Comparative Example 2 had the cracking and peeling of the thin film surface after operation. In Comparative Examples 1 and 2, since the overvoltage was high and the electrode was under strain during rapid charging and discharging under high current conditions, the cracking phenomenon in the electrode became more severe. Specifically, since Comparative Examples 1 and 2 used organic liquid electrolytes having high reactivity, a side reaction layer was formed on the surface of the electrode during the operation process. During the charge and discharge process, the silicon electrode may experience volume changes, the side reaction layer may not withstand this and collapse, and the surface of the electrode may be exposed. This forms a side reaction layer again, thereby causing the battery resistance to continuously increase. This was also a major factor putting a strain on the electrode, thereby causing the electrode to crack.

Referring to FIG. 2C, it can be seen that the amorphous Si thin film manufactured in Comparative Example 3, which used the electrolyte having low reactivity and changed the electrical conductivity variable, had a thin film surface that cracked after operation.

TABLE 2

| | Operation status | Surface stability | Surface photo |
|---|---|---|---|
| Example 1 | ∘ | ∘ | FIG. 2D |
| Comparative | ∘ | x | FIG. 2A |
| Example 1 | | | |
| Comparative | ∘ | x | FIG. 2B |
| Example 2 | | | |
| Comparative | ∘ | Δ | FIG. 2C |
| Example 3 | | | |
| Comparative | x | — | — |
| Example 4 | | | |
| Comparative | x | — | — |
| Example 5 | | | |

### Experimental Example 3: Evaluation of Life Characteristics of Lithium Secondary Battery

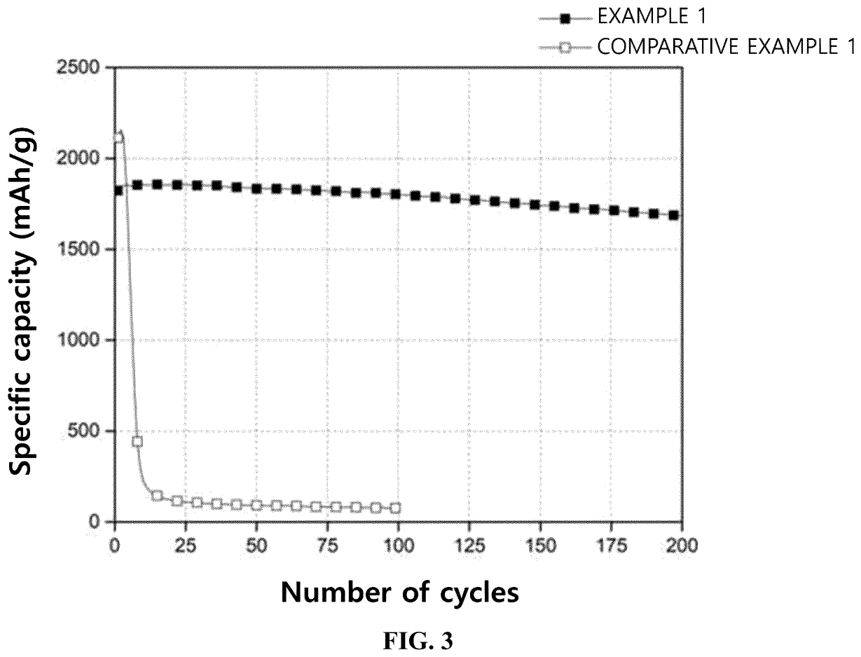

The charge and discharge life characteristics of the lithium secondary batteries according to Example 1 and Comparative Example 1 were evaluated, and the evaluation results are as shown in FIG. 3. The charge and discharge characteristic evaluation were measured by repeatedly performing charging and discharging under a current condition of 1 C at an operating voltage of 1.5 V to 0.1 V.

Referring to FIG. 3, it can be seen that the lithium secondary battery according to Example 1 exhibited better life characteristics than the lithium secondary battery according to Comparative Example 1. This shows that the lithium secondary battery according to Example 1 has excellent life characteristics because the negative electrode according to Example 1 has high electrical conductivity, has little side reaction with the electrolyte, and suppresses volume expansion by operating in a pressurized environment.

Although the present invention has been described above with limited examples, the present invention is not limited thereto, and various modifications and variations are possible within the scope of the technical idea of the present invention and the equivalent scope of the patent claims to be described below by a person having ordinary skill in the art to which the present invention belongs.

1. A lithium secondary battery comprising:
a negative electrode in which an amorphous silicon active material is laminated on a negative electrode current collector;
a positive electrode in which a positive electrode active material is laminated on a positive electrode current collector; and
an electrolyte having lower reactivity with the negative electrode,
wherein the positive electrode, the negative electrode, and the electrolyte are assembled under pressure.

2. The lithium secondary battery of claim 1, wherein the amorphous silicon active material has a thickness of 0.05 μm or more and 10 μm or less.

3. The lithium secondary battery of claim 1, wherein the amorphous silicon active material is doped with one or more elements of nitrogen, oxygen, phosphorus, and arsenic.

4. The lithium secondary battery of claim 1, wherein the amorphous silicon active material has a doping concentration of 1.0×10¹¹ atoms/cm³ or more and 5.0×10²² atoms/cm³ or less.

5. The lithium secondary battery of claim 1, wherein the amorphous silicon active material is disposed on the negative electrode current collector by a plasma-enhanced chemical vapor deposition (PECVD) method.

6. The lithium secondary battery of claim 1, wherein the negative electrode current collector includes one or more of Ni, Cu, Fe, Ti, C, Ag, and stainless steel.

7. The lithium secondary battery of claim 1, wherein the positive electrode active material includes an oxide including Li and at least one of Ni, Co, Mn, Fe, Al, Mg, and V, or a mixture thereof.

8. The lithium secondary battery of claim 1, wherein the positive electrode current collector includes one or more of Al, Fe, Ni, Ti, Ag, and stainless steel.

9. The lithium secondary battery of claim 1, wherein the electrolyte having low reactivity with the negative electrode is at least one of an oxide-based electrolyte, a halide-based electrolyte, a complex hydride-based electrolyte, and a sulfide-based electrolyte.

10. The lithium secondary battery of claim 1, wherein, when the lithium secondary battery is manufactured, pressurization is performed at a pressure of 4 MPa or more and 125 MPa or less.

11. A method of manufacturing a lithium secondary battery, comprising:
manufacturing a positive electrode by applying a positive electrode active material slurry including a positive electrode active material onto a positive electrode current collector;
manufacturing a negative electrode by depositing an amorphous silicon active material on a negative electrode current collector; and
manufacturing an electrolyte having low reactivity with the negative electrode, bonding the positive electrode to one surface of the electrolyte, and bonding the negative electrode to the other surface,
wherein the positive electrode, the negative electrode, and the electrolyte are assembled under pressure.

12. The method of claim 11, wherein the amorphous silicon active material has a thickness of 0.05 μm or more and 10 μm or less.

13. The method of claim 11, wherein the amorphous silicon active material is doped with one or more elements of nitrogen, oxygen, phosphorus, and arsenic.

14. The method of claim 11, wherein the amorphous silicon active material has a doping concentration of 1.0×10¹¹ atoms/cm³ or more and 5.0×10²² atoms/cm³ or less.

15. The method of claim 11, wherein the amorphous silicon active material is deposited on the negative electrode current collector by a PECVD method.

16. The method of claim 11, wherein, when the lithium secondary battery is manufactured, pressurization is performed at a pressure of 4 MPa or more and 125 MPa or less.
